(19) United States
(12) Patent Application Publication
(10) Pub. No.: US 2001/0037215 A1
(43) Pub. Date: Nov. 1, 2001

(54) Multi-user distribution system and center for diagnosis-related educational information and home medical tests and devices

(76) Inventor: Emilie Sparks, Montgomery Village, MD (US)

Correspondence Address: Richard C. Litman, LITMAN LAW OFFICES, LTD., P . O . Box 15035, Arlington, VA, 22215, US

(21) Appl. No.: 09/808,144

(22) Filed: Mar. 15, 2001

Related U.S. Application Data
(60) Provisional application No. 60/195,202, filed on Apr. 7, 2000.

(51) Int. Cl. G06F 17/60

(52) U.S. Cl. 705/2

(57) ABSTRACT

A medical, educational, and home healthcare materials distribution system for enabling medical subscribers to provide the best available diagnosis-related products to clients. A patient/user enters the system by presenting to a medical subscriber, either in person or by other means, to receive a medically-informed recommendation. The recommendation may be an oral communication, order form, or a special prescription pad. The medical subscriber may make suggestions to the patient/user as to appropriate educational materials and medical products or may rely entirely on the distribution center of the system to correlate the patient's diagnosis to preselected educational materials and home medical assessment or monitoring products. The patient may personally place orders through the system or have them ordered by the medical office. The distribution center ships the materials to the patient by mail and sends documentation of the transaction to the patient's physician's office.

### CROSS-REFERENCE TO RELATED APPLICATION

This application claims the benefit of U.S. Provisional Patent Application Ser. No. 60/195,202, filed Apr. 7, 2000.

### BACKGROUND OF THE INVENTION

1. Field of the Invention

The present invention relates generally to information distribution systems and more specifically to systems to assist physicians for providing diagnosis-related educational materials, as well as home medical tests and devices, to patients.

2. Description of Related Art

Numerous systems have been developed for facilitating the transfer or delivery of information to users—the Internet being the archetypal example in this field. Some of the most significant advances in the art of knowledge and expert systems have centered around medically-related information. Most of the conventional techniques herein described attempts to improve recordation of medical information or medical information management. However, none of these techniques presents a system for comprehensively ensuring that patients receive the best medical information and home medical tests and devices available for understanding and constructively addressing their medical diagnoses and related conditions.

For example, U.S. Pat. No. 4,621,729, issued to Jackson, discloses a portable patient medical information and education packet which includes a strip of material divided into a plurality of panels hingedly connected together such that the panels can be folded up to a relatively small size. The strip includes a pocket adapted to contain cards. The cards have medically related information on each side, but do not provide an effective system for educating the user about their diagnoses or conditions.

U.S. Pat. No. 5,181,743, issued to Lloyd, discloses a drug information request system whereby a consumer may request information regarding a particular drug. A doctor provides a patient with an information request postcard. The information request postcard may have a first information correlation component and a second postal destination component. The first component may comprise a plurality of correlation groups, each correlation group comprising an identification symbol and an associated check off section. A consumer identification section is also included for the insertion of postal information. The second component may have a destination information section comprising postal information of a distant site from which information about a drug associated with a designated identification symbol may be transmitted to a consumer using postal information present in the consumer identification section.

This invention is specifically designed to satisfy patient needs for additional pharmaceutical information, while the present invention is designed to satisfy physician needs for educational material to support the diagnosis specific educational component of treatment. In Lloyd, a patient requests information about a specific drug because of an interest in the information, while in the present invention the patient orders heath education products by diagnosis after a recommendation is given to them by their own healthcare provider; the products are then sent to the patient by mail or U.S.P.S. Thus, the patent to Lloyd relates to an invention which is not nearly as comprehensive, holistic, or educative as the present invention. Other differences in the Lloyd patent and the present invention will become readily apparent through the preferred embodiment discussed hereinbelow.

U.S. Pat. No. 5,799,981, issued to Tung et al., discusses a pharmaceutical marketing device and system which enable a company or a designated representative to communicate with other persons involved in the marketing and administration of medical products such as a physician, patient, or a pharmacist. The marketing device comprises multiple, separable segments. These segments can include a product information segment to be affixed to a patient's chart, a mailer segment to be returned to the manufacturer of a product or to the manufacturer's representative (including patient related information), and instructions to the pharmacist to dispense a specified quantity of a medical product. The marketing device can include a pharmacist receipt segment to be signed by the recipients of free products and a blank check segment made payably to the endorsing pharmacist. A pair of prescription segments, a product sample segment, and a patient-education segment for providing information to the patient regarding the disease being treated may also be provided.

U.S. Pat. No. 5,867,821, issued to Ballantyne et al., relates to a method and apparatus for the distribution and administration of medical services, entertainment services, electronic medical records, and educational information to a patient's individual electronic patient care system, interconnected to a master library through a local medical information network. Patient and medical personnel interact with this medical information through the electronic patient care system and receive the requested service or data from the master library. The data is then displayed either on an associated television set or video monitor or through conventional communications systems to a peripheral personal data assistant. The data for text, audio, and video information is all compressed digitally to facilitate distribution and only decompressed at the final stage before viewing/interaction.

U.S. Pat. No. 5,951,300, issued to Brown, shows an on-line system and method for providing entertainment and health-related information comprising composites of personalized health content and patient-selected entertainment. Suitable sources of entertainment include web pages and television programs. Composites are spatial (for page displays) or temporal (for image sequence displays). Health content is customized to health and personal situations of individual patients, and replaces advertisements. Composites are generated on a central server. Amenable diseases or behaviors include diabetes, asthma, hypertension, cardiovascular disease, eating disorders, HIV, mental health disorders, smoking, and alcohol and drug abuse.

U.S. Pat. No. 5,953,704, issued to McIlroy et al., discusses a health care management system for use by hospitals, physicians, insurance companies, health maintenance organizations, and others in the health care field. The system includes a processing unit and health condition guidelines. A user inputs information related to the health condition of an individual, and guideline treatment options are identified. The user also inputs actual or proposed and final recommendation treatments for the same individual. The resulting comparative information can be used to modify the actual or proposed treatment, or provide explanatory information as to reasons for the difference between the recommended treatment and guideline treatment options. Also, the comparative information can be used by a reviewer for evaluation or utilization purposes.

U.S. Pat. No. 5,999,909, issued to Rakshit et al., discloses a method for establishing a certifiable patient informed consent for a medical procedure, where, in one embodiment, the patient interacts with a video training system until mastery of all required information is successfully achieved. Training techniques which permit elicitation of measurable behaviors from a patient as a guide to discerning the level of knowledge of the patient are utilized. Certification is only granted when the measurable behavior approximately coincides with the legal and medical standards for establishing informed consent. The system is capable of adapting to various medical procedures, as well as various patient attitudes and knowledge bases.

And finally, the Japanese Patent granted to Kazuo et al (JP 9016064) presents a patient educational system, and the Japanese patent granted to Kuniaki et al. (JP 9,282,400) shows a communication system for patients.

None of the above inventions and patents, taken either singly or in combination, is seen to describe the instant invention as claimed.

### SUMMARY OF THE INVENTION

The Multi-user Distribution System for Diagnosis-related Educational Information and Home Medical Tests and Devices is directed to a workflow, system, and service for enabling professional medical subscribers to the system, such as physicians, registered nurses, physician assistants, health education specialists, and nurse practitioners, to provide their patients with the best educational information relative to their diagnoses. The distribution system includes a simple means for authorizing access, namely presentation to a medically knowledgeable member of the system or subscriber—either in person or by any other means other than in person—to receive an “Education Prescription.” An Education Prescription is a medically-informed recommendation, which may take its form as an oral communication, an order form, or a special prescription pad (which the physician subscriber receives as part of the service).

In an alternative embodiment of the invention a client/patient/user may directly request educational and related materials from the system, for example, by logging onto the system and making an informed request based on a previously given diagnosis. It should be further understood that associated home medical tests and devices are encompassed within the idea of the Education Prescription, as modern healthcare has evolved to the point where proper management of illnesses may involve more active components such as regular self-testing. The physician may make recommendations to the patient as to appropriate educational materials and/or medical tests/devices or may rely entirely on the distribution center of the system to correlate the patient's diagnosis to preselected educational materials, medical tests, and medical devices.

The educational and other health-related materials are derived through the consensus of experts. Patients can order by phone, fax, e-mail, online, or mail. Alternatively, medical office staff can order for the patient or materials can be ordered electronically or automatically. The present invention envisions that an Education Prescription may involve an order being automatically generated by the system in response to a diagnosis given by a health professional. Patients receive the materials in the form of self-learning medical modules. The materials are derived from a wide variety of publishers and carefully selected through a consensus-based survey of experts in the field.

Accordingly, it is a principal object of the invention to provide a Multi-user Distribution System for Diagnosis-related Educational Information and Home Medical Tests and Devices for educating patients about what their diagnosis is, what they need to do regarding their diagnosis, prevention, and when to seek additional medical help.

It is another object of the invention to provide a system as above which saves time and resources to allow physicians to more fully address their patients' medical needs for educational materials.

It is a further object of the invention to provide a system as above that insures that patients receive the best available educational materials and medical tests/devices concerning their diagnoses.

It is another object of the invention to provide a system as above wherein physicians can be certain that their patients have educational information about their diagnoses, even if the patient is remotely diagnosed by a physician.

It is another object of the invention to provide a system as above whereby patients may order educational materials corresponding to their diagnoses.

Still another object of the invention is to provide a system as above designed to fulfill regulatory requirements of medical institutions to educate their patients.

It is an object of the invention to provide improved elements and arrangements thereof in an apparatus for the purposes described which is inexpensive, dependable, easily integrated into current healthcare practices, and fully effective in accomplishing its intended purposes.

These and other objects of the present invention will become readily apparent upon further review of the following specification and drawings.

### BRIEF DESCRIPTION OF THE DRAWINGS

FIG. 1 is a general block diagram of the Multi-user Distribution System for Diagnosis-related Educational Information and Home Medical Tests and Devices, according to the present invention.

FIG. 2A is a schematic block diagram of the workflow of the Multi-user Distribution System for Diagnosis-related Educational Information and Home Medical Tests and Devices, according to the invention, continued on FIG. 2B.

FIG. 2B is a schematic block diagram of the workflow of the Multi-user Distribution System for Diagnosis-related Educational Information and Home Medical Tests and Devices, according to the invention, continued from FIG. 2A.

FIG. 3A is depiction of a the front side of a request card of the Multi-user Distribution System for Diagnosis-related Educational Information and Home Medical Tests and Devices, according to the invention.

FIG. 3B is a depiction of the back side of the Multi-user Distribution System for Diagnosis-related Educational Information and Home Medical Tests and Devices, request card seen in FIG. 3A, according to the invention.

Similar reference characters denote corresponding features consistently throughout the attached drawings.

### DETAILED DESCRIPTION OF THE PREFERRED EMBODIMENTS

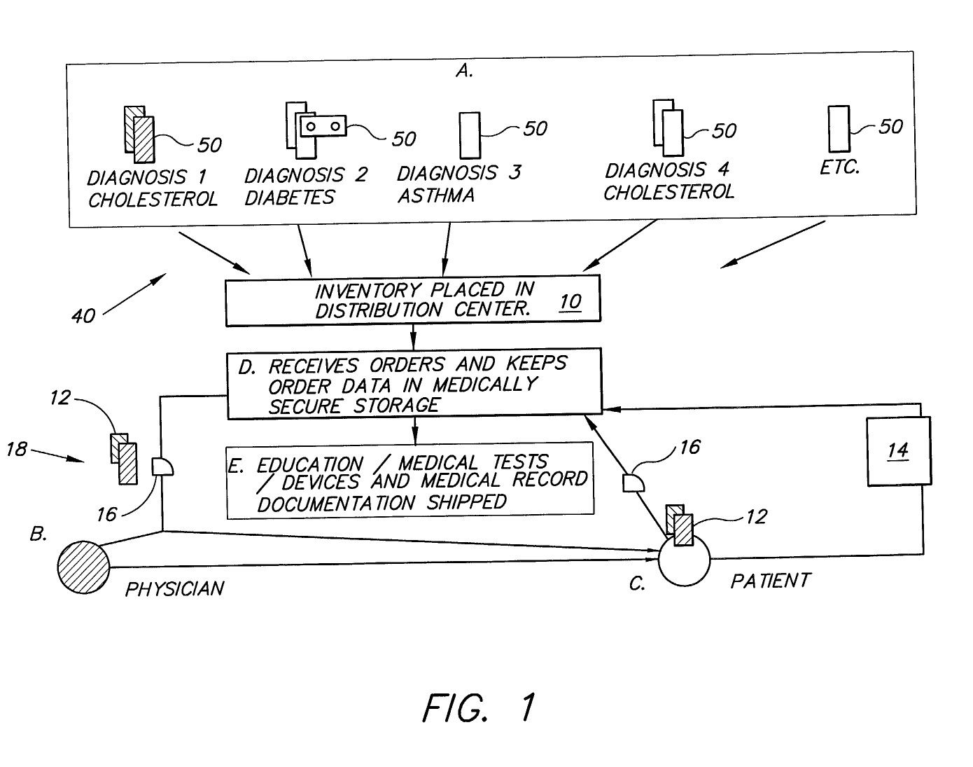

The present invention provides a system whereby a patient-user may request and receive informational material and home medical tests and devices, customized to their particular diagnosis or health-related condition. The preferred embodiment of the present invention is depicted in FIGS. 1-3B, and generally referenced by numeral 5.

Holistic, preventive, and home-related medical care have increased in importance as the nation becomes ever more concerned about the high costs of medical care. Education is a critical part of this therapeutic process, but is most effective when used synergistically with the fruits of modern technology. Home medical assessment and monitoring products are a valuable, practical, and even necessary component to the proper utilization of educational resources. For example, diabetics are required to monitor their blood sugar levels and regulate their intake of foods based on these levels; education about their caloric intake and the symptoms of their disease process is best used concomitantly with home monitoring and assessment products in order to achieve maximum health benefits.

The medical maintenance of many illnesses and conditions requires patients to submit samples or undergo tests of various kinds from time to time, or requires the use of different medically-related equipment at different stages of the disease/recovery process. Of course, proper knowledge of the purpose and correct execution of these requirements and practices is essential to patient compliance. If a system could be developed which would allow patients to address these needs in a comprehensive and integrated fashion, a valuable contribution to the art would be made.

The Multi-user Distribution System 5 for Diagnosis-related Educational Information and Home Medical Tests and Devices fulfills the therapeutic needs of many patients, allowing them to be equipped with the best available educational materials, along with the most up-to-date consumer medical tests and devices—creating a virtual synthesis of the best that modern medicine has to offer in terms of comprehensive, holistic care, outside of the parameters of classic pharmacotherapy and clinical practice.

As diagrammatically illustrated in FIG. 1, the Multi-user Distribution System 5 is presented in general block-diagram. As indicated alphanumerically, the core features of the System 5 comprise means for preselecting medical information packets or learning sets at A, means for recommending and receiving authorization to use the System 5 at B, and means for ordering the information at C. Also included are an inventory distribution center at 10 to manage requests for information at D, and means for documenting the shipment of orders and delivering requested information and devices in the form of modules, generally 18, to a patient or to that patient through a physician, represented at E.

Additionally indicated are means for accomplishing payment for the service at 14, such as by credit card, and means for delivering home medical tests and devices, generally represented by 16. Likewise, test results may be transmitted from the patient at C by mail or any other conventional means to be stored, processed, transmitted, or otherwise conveyed to the patient's health care provider. Thus, an effective platform is created whereby pertinent therapeutic information may be communicated to a health care provider. In an alternative embodiment, the results of clinical home assessment tests may be sent directly to the healthcare provider or medical office records department.

In embodiments of the invention where the patient is not able to physically meet with his/her healthcare giver, preferred technical implementation platforms are by conventional telephone means; however alternative platforms include the United States Postal Service, Federal Express (or similar services) fax, e-mail, or online (Internet or other networked systems), the various usages of which are further described hereinbelow.

Entrance into the System 5 may be governed by any appropriate means (as well as free access to all comers) including conventional computer security architectures based on identification and authentication of individuals requesting access to the central distribution center D. Such processes may also comprise auditing means to monitor user access for recordation of medically appropriate data, including demographic information.

Various levels of security may be applied to different parts of the System 5 to allow, in one embodiment, for first-time users to freely enter the System 5 and order information based on their diagnosis, to another embodiment, wherein a user may remain anonymous, the materials being shipped to them through a third party or health care provider. Regardless of whatever system is implemented, any medical information provided by the user to the System 5 always remains confidential.

In the preferred embodiment of the System 5, a professional healthcare subscriber to the system (such as a physician or a Health Education Specialist) would be provided with a code or other identifier such as a Subscriber Identification Number (SIN) to allow for entry into the System 5. In such an instance, the subscriber could call the distribution center, confirming membership in the System 5 by providing the SIN number by voice or touch pad technology. In an online embodiment of the invention, the health care provider could provide the patient with the provider's SIN number to allow patients to access the System 5 themselves or could delegate the task to a staff member. This would allow the health care provider to monitor the patient's usage of the System 5 by virtue of audit trails associated with each usage of the SIN number by the patient, which could also be electronically incorporated into the patient's permanent medical record for documentation and regulatory purposes.

The present invention makes an important contribution to the art by providing an almost effortless way by which physicians and other medical subscribers to the System 5 can make educational recommendations or “Education Prescriptions” to their patients and accomplish the goal of integrating the education into the patient's treatment plan. These educational recommendations may comprise instructions to acquire and use medical assessment tests (such as products for measuring various metabolic functions commonly sold in pharmacies and medical equipment stores) and home monitoring products. Other examples of home medical tests which can benefit from an educational component include pregnancy tests, various environmental lead tests, alcohol screens, and drug tests.

The present System 5 satisfies a need which has long existed in the art for an effortless way for healthcare professionals to add an effective educational component to their patient treatment plan, along with the best in consumer home healthcare technology, to affirm, emphasize, and validate the education they give verbally. The System 5 seamlessly integrates traditional medical care, patient education, and home health care, combining the doctor's directives with consumer medical tests and devices and life-empowering knowledge, to give patients the most effective combination of therapy, practical information, and treatment available.

A. Background

It is generally argued that there are at least five reasons that physicians do not provide educational materials to their patients:

(1) They do not know what materials are available.

(2) The materials are not on hand when the need for them arises (i.e., when the patient is with the doctor).

(3) They run out of the materials.

(4) They do not know how to order materials,

(5) There is no place to store the materials.

Despite these obstacles, most physicians continue to make efforts to explain medical diagnoses and procedures to their patients, to both instruct them and involve them in the treatment decision. Patients want information, but trust their doctors to make the right decisions.

This System 5 will not replace verbal interaction between patients and physicians. Rather, the System 5 will enhance and complement the existing patient/physician milieu. And physicians readily agree that when patients understand their illnesses, a valuable contribution is made to a positive medical outcome. Nevertheless, one of the weakest links in the doctor-patient process is communication. Printed educational materials have been shown to improve patients' perception of doctor/patient communication. Even when patients receive an explanation of their illness from their doctor, it is not unusual for them to fail to fully understand it or forget most of what was said to them.

The importance of education and health was underlined in a recent study by Channing L. Bete that found that after reading health-improvement booklets, both average and low literacy adults showed a marked increase in reported intention to take action to improve health. Thus, major strides in health improvement and patient compliance can be made when patients receive materials related to their diagnoses. But there are significant problems in relying upon verbal education alone to fulfill this need—a need which is apparently innate to the physician/patient milieu. For example, most patients do not begin to formulate questions about their medical diagnosis until about 19 minutes after their first contact with the physician.

Since physicians frequently need to maximize the number of patients they see in a day, it is often impossible for them to spend enough time so as to enter into a comprehensive therapeutic dialogue with all of them, resulting in many patients coming away from their medical appointments feeling confused and afraid—even when their doctors have provided them with adequate verbal instruction.

In the December 1991 edition of the New England Journal of Medicine, it was found that many of the problems in patient behavior, such as a noncompliance, medication mistakes, ignorance of danger signs, etc., may stem from conventional practices of verbal information delivery. Patients desperately want and need more and better educational information from their doctors.

Patient satisfaction with the overall quality of their medical care has been linked to the receipt of written educational materials. Thus, the increased availability of knowledge resources can, not only contribute positively to medical outcomes, but can also significantly impact on the satisfaction patients feel with the doctors, nurses, and other health professionals they encounter. When this occurs, both care giver and patient are happier, and patients are much less likely to consider a malpractice suit. A System 5 which can help physicians and other healthcare providers improve the quality of a patient's knowledge about their illness can, therefore, make a valuable contribution to both individual and society.

B. Discussion of the System

As illustrated at FIG. 1, the nexus of the System 5 comprises a main distribution center D which collects, maintains, and dispenses preselected informational materials and home medical tests and devices arrived at through consensus-based processes wherein healthcare experts are surveyed regarding the best sets of educational materials and related medical assessment or monitoring products for a particular diagnosis, as indicated at A.

Throughout this specification, it should be understood that “education” and “educational materials” may comprise information about various medical assessment and monitoring products, as well as the directions or indication to procure these products with their use. However, the preselecting of these materials, tests, and devices by experts is a critical feature of all embodiments of the invention.

Turning again to FIG. 1, educational materials, shown as correlated to particular medical diagnoses—Diagnosis 1, Diagnosis 2, Diagnosis 3, Diagnosis 4, each generally 40—are culled or selected from what is currently available in the marketplace. The System 5 is unique in that it allows for customization of patient educational resources to a particular diagnostic constellation. For example, a patient with HIV, back pain, and stress symptoms might be provided with education, on the one hand, related to HIV (including nutrition, human sexuality, and maintaining mental health) and, on the other hand, with educational materials related to back exercises and stress reduction; simultaneously, the System 5 would allow for distribution of medical devices and tests such as specialized exercise equipment and stress reduction devices such as a biofeedback device.

It should be understood that, as a term of reference, “Education Prescription” primarily refers to the prescription order itself whose origin is solely with the medical care giver (R.N., M.P.H., R.N.P.) or physician B, as opposed to the medical kit or module 18. Furthermore, a subscriber may use any means by which to provide the education prescription to the patient including via Internet, mail, e-mail, online, fax, carrier, and phone.

The medical kit or module 18 contains at least one of the following materials: knowledge resources 12, home medical tests 16, or home medical devices, also represented for purposes of the specification by 16. Individual units of education or medical devices and tests are represented at 50. And so the medical module 18 may be defined as the assemblage together of at least one packet or set 40 of materials 50 for comprehensively addressing a person's health care conditions, symptoms, or medical diagnosis (or diagnoses). In short, the sets of materials are represented at 40, while the individual components are represented at 50.

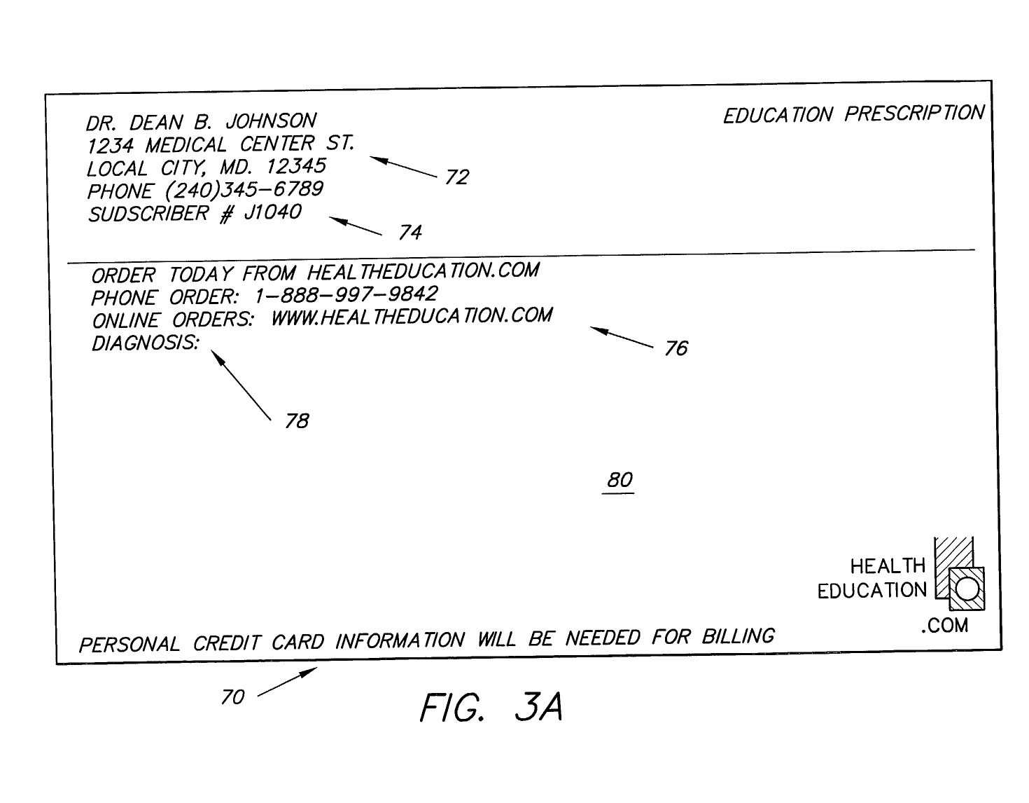

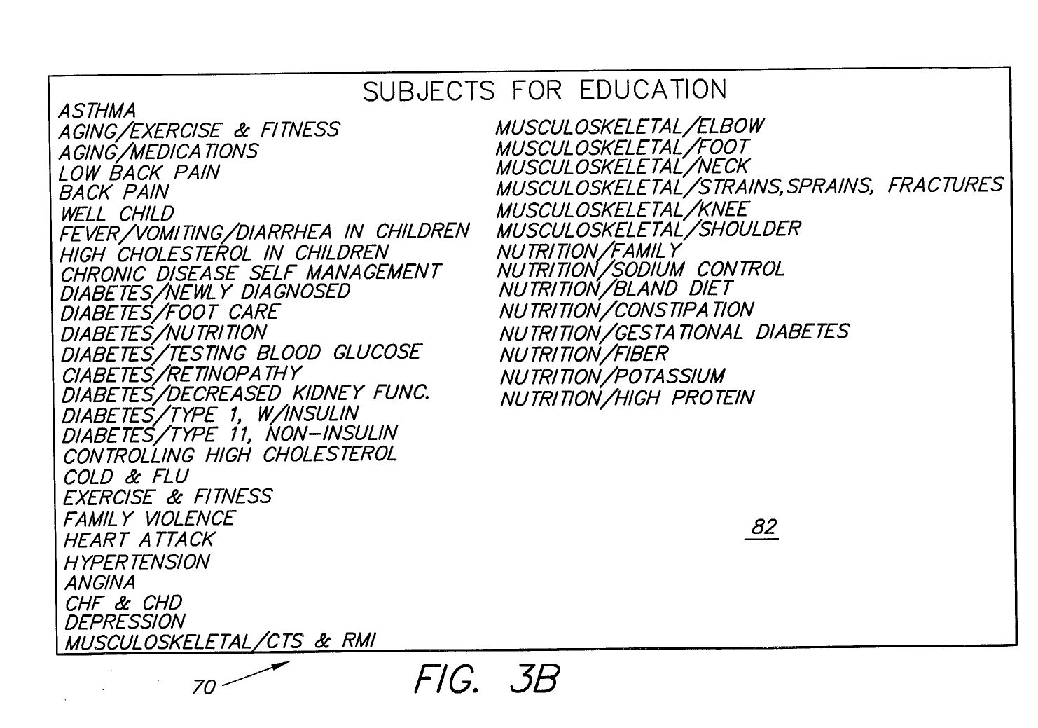

For descriptive purposes, this specification will not use “Education Prescription” as having alternative meanings of both the prescriptive form (which the doctor completes) and the filled order (which the distribution center D sends to the patient), in order to not mirror the practice in the common parlance, regarding prescriptions for drugs, of confusing the two terms together. An Education Prescription in the context of the present invention comprises the diagnosis correlated directive of the physician, which, in the preferred embodiment, is recorded on sample form 70, seen in FIGS. 3A and 3B.

Selection of appropriate individual materials, generally 50, for inclusion in the central library or database of the distribution center D is achieved primarily in one of three ways: (1) expert selection, (2) consensus selection, and (3) nationwide selection. In expert selection, materials 50 are selected and synthesized into a set 40, drawing from all available sources by Certified Health Education Specialists, Registered Nurses, or other professional health educators. The medical content of each set 40 is then validated or otherwise determined to be medically correct by a board-certified physician.

In consensus selection, expert consultants and a predetermined review process are used to select the best medical devices/tests and/or educational materials 50 to be used for a certain diagnosis. Again, the resulting selection is approved by a board-certified physician. In nationwide selection a geographically broad group of experts is consulted to select the best available medical devices/tests and/or educational materials for patients with a given diagnosis.

Groups such as various health-related national coalitions, foundations, institutes, colleges, and local or national groups comprising licensed, graduate, and/or certified, medical experts can be surveyed using a consensus building process to find the best materials 50 for patient education and diagnosis. The resulting set 40 for each diagnosis would then be validated by a top physician expert. In an alternative embodiment, these selections could be approved for national use by a nationally recognized figure such as the Surgeon General.

A wide variety of content sources are available from which to draw educational material, including the National Institutes of Health, the American Academy of Pediatrics, and the National Dairy Council (for nutritional topics). It should be understood that this specification embraces any sources or kinds of educational materials including pamphlets, records, books, brochures, audio tapes, video tapes, CDs-ROM, other learning media, medical tests and devices. Under the copyright laws, ownership of content would remain with the authors, the System 5 acting primarily as a vehicle for their distribution.

This specification further envisions that some educational materials may be interactive or may entail further processing by the distribution center D after being employed by the patient. For example, educational materials could comprise psychological tests or educational tests or devices to complement the learning process. Furthermore, means are envisioned to determine patient and subscriber satisfaction with the System 5, in order to improve the delivery of services.

The main distribution center D could comprise a simple, indexed library or a centralized, database containing the various expert selection sets or packets 40. Nevertheless, it should be understood that this specification embraces any means for managing and maintaining the inventory distribution center D.

It is important to stress again that all aspects of the patient's interaction with the System 5 are secure and confidential—a benefit insured by the private, subscriptive/prescriptive nature of the System 5. Moreover, the System 5, itself, allows for updates in the individual sets 40 and materials 50. In the preferred embodiment of the invention, this could entail a consensus-oriented process involving the expert groups discussed above, as well as the healthcare professional subscribers in the System 5.

Alternatively, the medical modules 18 could be periodically quality checked by healthcare personnel. But these processes are not limited in terms of where or how they may occur; for example, meetings of experts might occur in cyberspace or through networked or other communication systems.

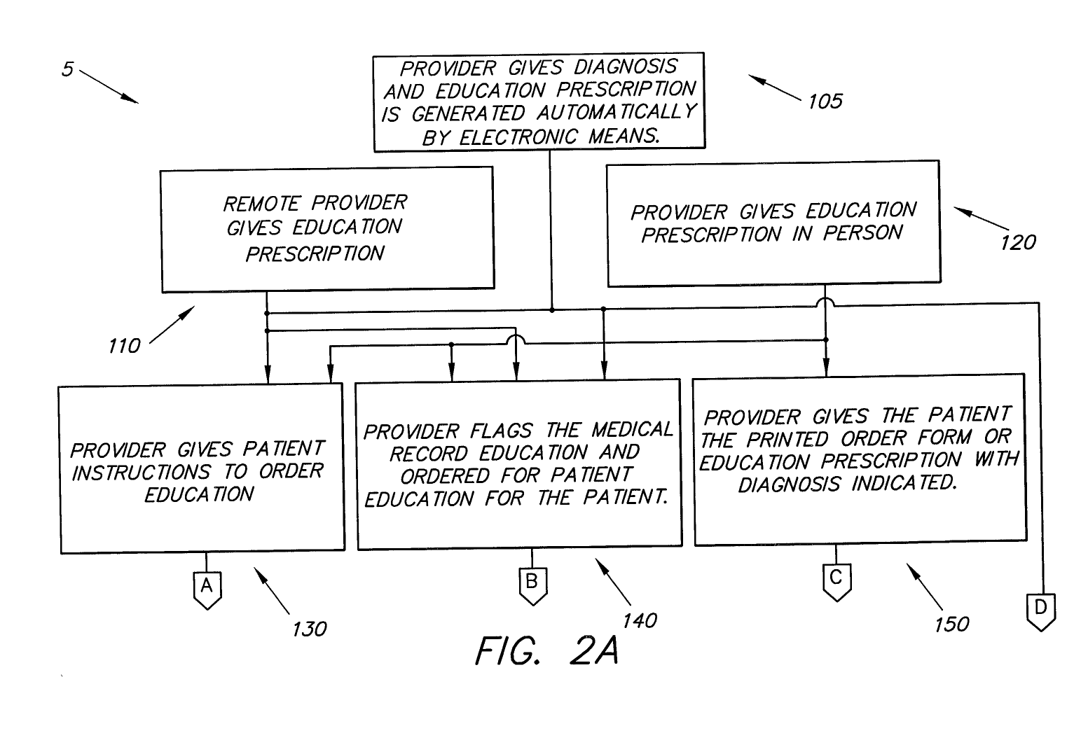

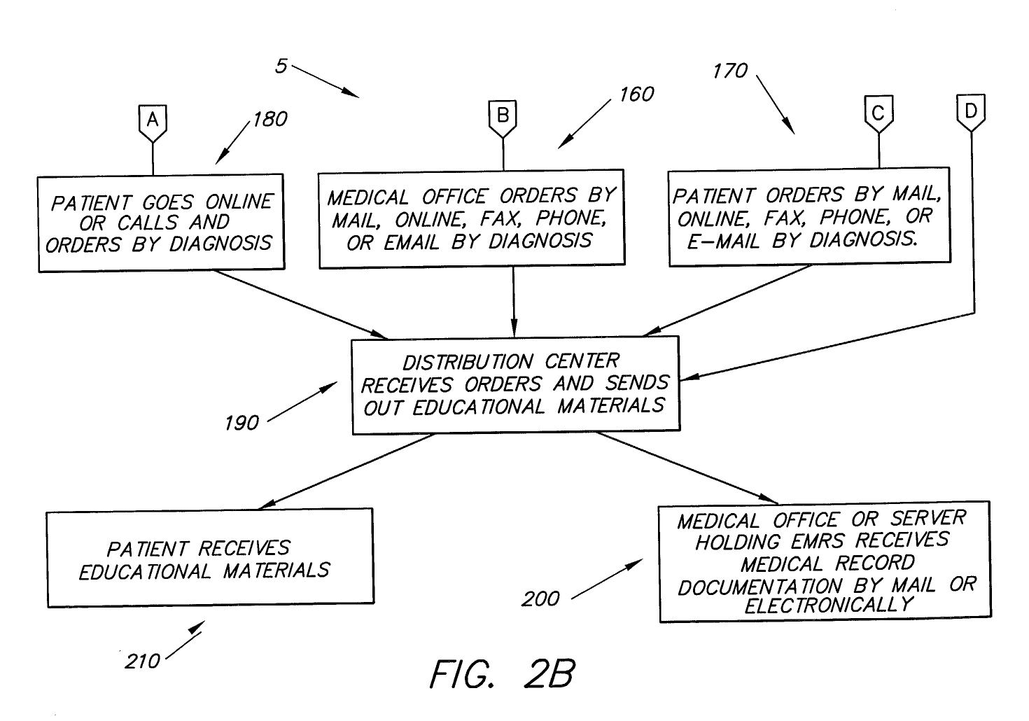

Referring now to FIGS. 2A and 2B, in the preferred embodiment of the invention, entry into the System 5 begins after a patient presents to a health care provider and is given a diagnosis. The healthcare provider is typically an osteopathic or allopathic physician, PA, RNP, or other healthcare professional, who subscribes to the service and receives prescription pads and order forms as a regular part of the service or has integrated an ordering process into their electronic medical record system. Ideally, the patient presents to the physician in person (step 110); however the patient may also present by any means other than in person (step 120), including through telephone, online, or other communication lines.

Around the country, Tele-medicine is being increasingly used to address the health needs of under served areas, such as Indian reservations and the rural South. The present invention could make a valuable contribution to Tele-medicine, allowing clients in even the most rural parts of the country full access to the best health care educational information matched to the best home medical tests and devices.

It should be stressed at this point that the distribution center D could also comprise electronic means by which the “Education Prescription” may be automatically generated, whereby the patient requests and automatically receives education and/or medical tests/devices based on a diagnosis they have previously received from a healthcare professional (step 105). Such a process could be initiated automatically when the patient's diagnosis is entered into the provider's database or medical records.

Thus, materials could be ordered electronically by physicians, nurses, and health educators who use “smart” systems or, alternatively, by individual patient-users at their own initiative. “Smart” systems are built into the electronic medical record systems. An order is generated electronically without additional action from the attending physician when a diagnosis is recorded. These orders can then be forwarded to the distribution center D for distribution.

If the patient presents to a provider by any means other than in person (step 110), along with a diagnosis, the provider may give the patient instructions to order (step 130) the medical modules 18 by either telephone, online, or through e-mail. Alternatively, the provider may flag or designate medical office staff to order (step 140) the medical modules 18 on behalf of the patient. Any office system or other means conventionally known and practiced in the art for flagging or otherwise designating medical office personnel to make such an order may be used, as well as any implementation platform including office Intranet or LAN. Subsequently thereto, the medical office orders the designated module 18 by mail, online fax, phone, e-mail (step 160), or equivalent means.

The Prescription Education System 5 is designed with the knowledge in mind that not every patient will be able to order their own materials. For example, as a customer service or if a patient is illiterate or severely disabled, the provider may simply flag the patient's medical record, and the medical office will place the necessary order directly for the patient. As the medical office preferably always is sent a record of the modules 18 shipped out, the patient need never be troubled with the details of the ordering process.

Documentation of educational interventions 30 in report form are important for the patient's medical record, for healthcare regulatory and accreditation purposes, and for other healthcare management, case study, research, and public health uses. Of course, medical modules 18 may be handed to the patient on-site by the physician or medical office personnel, when sufficient sets 40 of materials 50 are available.

In the preferred embodiment, if the provider meets the patient in person, the provider would give the patient the printed order form (step 120). The provider could then give the patient instructions to order as in step 130 or flag the medical record as in step 140. Alternatively, the physician could simply rely on the written instructions for ordering on the printed order form, the diagnosis appropriately indicated by the physician thereon (step 150).

The most typical environment for step 150 would be the doctor's office, and, after receiving the Prescription Education form 70, the patient would place their order by mail, online, fax, phone, or e-mail by diagnosis (step 170).

As previously noted, the patient would receive an Education Prescription Card or Form 70 from the physician, the preferred embodiment of which is shown in FIGS. 3A and 3B. On the front side 80, the Education Prescription form 70 resembles a conventional prescription pad, containing indicia thereon, indicating the doctor's name and address 72 and other identifying indicia, including the subscriber number 74, along with the phone number and web address 76 of the medical modules 18 distribution center. Also, indicated is a place for the patient's diagnosis at 78.

Any other suitable information which would be helpful to the patient may be included. On the back side 82 of the card 70 may be found a list of common ailments, or a series of representative diagnoses which have available educational sets 40. It should be understood that this list is only a sample of possible diagnoses. The physician may circle or check one of these; alternatively, or in combination therewith, the physician may write the diagnosis on the space provided at 78. Thus, the System 5 should be found agreeable in even the busiest medical setting.

In an alternative embodiment of the Education Prescription form 70, a form having a series of medical topics along with commonly associated diagnoses, syndromes, or health care issues could be listed. Each diagnosis could have a check box for marking as indicated, along with a price quote for the educational set 40 associated therewith. Examples of these topics might include a major topic of “Musculoskeletal” with the related areas of “Carpal Tunnel Syndrome,” “Neck,” “Sprains, Strains, Fractures,” “Knee,” “Shoulder,” “Foot,” and “Elbow” listed underneath. For the major topic area of “Cholesterol,” related areas might be “Controlling High Cholesterol,” and “Cholesterol and Low Fat.” For the major topic of “Smoking,” only the related area of “Smoking Cessation” might be listed; other areas might be added at another time. For “Women's Health,” the related areas of “HRT” or Hormone Replacement Therapy, “Menopause,” “Breast Lumps,” “Breast Health,” and “General” would be likely topics for inclusion. In each case, the price of the module 18 would be shown.

In this embodiment, a prominent ordering section would be located at the bottom of the page with brief instructions indicating to either mail, fax, order online, or order by phone. Places for the patient's name and address, a method of payment, web address, postal address, and fax and phone numbers could also be included. As in the preferred embodiment, indicia denoting the doctor's name and address would be prominently displayed.

As previously discussed, a patient may receive the Education Prescription by any means other than in person (step 110); logically, therefore, a patient might telephone his primary care physician and either receives instructions for ordering over the phone from the physician or the physician would alert the medical office, also possibly by phone. Thus, the physician need not be on the same premises as his office to use the System 5. The patient, in turn, would follow the provided dialing instructions to order the appropriate medical module 18 by diagnosis (step 180). It can be clearly seen that all the steps prior to step 190, in which the distribution center receives the order and sends out the educational materials, may be done telephonically.

Whether the provider gives the Education Prescription in person (step 120) or by any other means than in person (step 110), the patient may personally call the distribution center (step 180) to order educational material. The patient would simply dial a phone number provided on the card. The distribution center could be manned by personnel for receiving incoming calls, or be equipped with automatic voice or push button technology. After responding to the appropriate series of prompts, messages, or questions, the order would be recorded, the modules 18 shipped out, and the patient will subsequently receive the requested medical modules 18 by U.S.P.S. or other domestic carrier, as noted in FIG. 3A. at step 210; the medical office will receive supplemental documentation (step 200) or other appropriate identifiers of the materials supplied for medical records, insurance, and other purposes. Thus, the term “carrier mail” in the context of the specification and claims refers to any commercial or governmental postal or package delivery system. The provision of this supplemental documentation of transaction function (step 200) is an important benefit of a subscription to the service. It should be stressed that delivery of modules 18 to the consumer is never by electronic methods.

In an alternative embodiment, the patient could access a website of a physician subscriber to the service—such a website might even have online healthcare expertise and be capable of using instant message technology such as conventionally found in chat rooms. For example, a web-based physician subscriber could make appropriate recommendations for medical modules 18 online. A web-based site could also comprise data-processing means or serve only as means for ordering material. Content of the site would preferably comprise a hypertext markup language (HTML) document and might also allow for personalized health-related messages. This specification envisions all formats for networked content delivery and interactivity, including java scripts, applets, or VRML (Virtual Reality Markup Language).

Conventional web sites generally include an original or home page, clickably connected to a plurality of other web pages through a menu hierarchy. An input, interaction, or other selection means would be included for ordering educational information. The System 5 obviates the necessity of the implementation of a decision tree as all educational sets 40 have been pre correlated to a specific diagnosis. Advertising and health-related messages could also be part of the site, and conventional means for assisting content delivery including audio, hypertext, video, JPEG, MPEG and equivalent technologies are fully encompassed. Conventional client/server technology and software authoring tools are employed, though the System 5 may implement specialized hardware and software.

Thus, it can be clearly seen that the distribution center D may be operated as an online business. After accessing the web address through personal or public computer terminals, a catalogue or ordering site could be provided from which the patient would choose the desired materials, correlated to the diagnosis given to them by the practitioner. This specification should be understood to comprise the menu hierarchy of a website or other networked system corresponding to the steps of the method, the System 5 herein described, or any equivalent or combination thereof. mentioned previously, in accordance with the present invention, health-related educational information, whether in machine-readable form, printed materials, or media of any other kind, may be stored at and dispensed from a distant site. This will free health providers from the necessity of storing the required documentation in their offices, which can deplete vital storage space; it will also free the physician from the task of reviewing the information to verify that it is current. Therefore, the only material which will ever have to be stored at the office of the healthcare provider will be the education prescription forms themselves which, in alternative embodiments, are replaced by direct online orders.

In other alternative embodiments the patient could correspond to the physician by fax or e-mail; using these methods, patients would be able to send physicians copies of their medical record for a detailed evaluation of their cases.

Other advantages of the distribution System 5 include the method of providing a patient with diagnosis specific pre-selected materials from healthcare experts comprising the general steps of:

(1) Preselecting health-related educational materials and medical tests/devices;

(2) presenting the patient to a physician in the physician subscriber system, wherein said presenting is direct and remote;

(3) distributing an education prescription to a patient;

(4) requesting a medical module corresponding to a specific diagnosis of a patient's medical condition from the subscriber system, and

(5) receiving a medical module from the subscriber system.

It is to be understood that the present invention is not limited to the sole embodiments described above, but encompasses any and all embodiments within the scope of the following claims.

I claim:

1. A multi-user distribution system for providing a patient with selective, diagnosis-related educational information and medical products, comprising:
(1) means for inputting a patient's request for material;
(2) means for correlating said request with at least one preselected material by diagnosis;
(3) means for delivering at least one said material to said patient as a medical module;
wherein said material(s) are selected from the group comprising educational products, medical assessment tests, and medical products.

2. The multi-user distribution system for providing a patient with selective, diagnosis-related educational information and medical products of claim 1, further comprising a medical module and means for combining at least one said material into a medical module to be sent to said patient.

3. The multi-user distribution system for providing a patient with selective, diagnosis-related educational information and medical products of claim 2, wherein said means for delivering said medical module to a patient is carrier mail.

4. The multi-user distribution system for providing a patient with selective diagnosis-related educational information and medical products of claim 3, wherein said means for receiving a patient's request for information is selected from the group comprising mail, fax, e-mail, online, networked systems, carrier, and telephone.

5. The multi-user distribution system for providing a patient with selective diagnosis-related educational information and medical products of claim 4, wherein said medical module is a self-learning module.

6. The multi-user distribution system for providing a patient with selective, diagnosis-related educational information and medical products of claim 5, wherein said medical module comprises educational products which are diagnosis specific, said materials having been preselected and validated by at least one expert.

7. The multi-user distribution system for providing a patient with selective diagnosis-related educational information and medical products of claim 6, wherein said medical module further comprises consumer medical assessment and monitoring products preselected by healthcare experts;
said system further comprising means for receiving results from said medical assessment products for transmittal to a heath care provider, and means for receiving data from said medical products for conveying said data to a healthcare provider, said medical assessment products.

8. The multi-user distribution system for providing a patient with selective diagnosis-related educational information and medical products of claim 7, wherein said medical module further comprises health-related educational materials preselected by healthcare experts;
said system further comprising means for receiving responses to said educational modules, said responses being based on said patient's educative interaction with said modules.

9. The multi-user distribution system for providing a patient with selective diagnosis-related educational information and medical products of claim 8, wherein said health-related materials are up datable over time, said system further comprising means providing for updating said materials.

10. The multi-user distribution system for providing a patient with selective diagnosis-related educational information and medical products of claim 9, wherein said means for processing patient's information request further comprises means for documenting the shipping-out of said health-related materials for said medical record.

11. The multi-user distribution system for providing a patient with selective diagnosis-related educational information and medical products of claim 10, wherein a patient may present said patient's information request to said system in person or by any means other than in person.

12. The multi-user distribution system for providing a patient with selective diagnosis-related educational information and medical products of claim 11, wherein said system further comprises a database.

13. The multi-user distribution system for providing a patient with selective health-related educational information and medical products of claim 12, wherein said system further comprises medical devices and medical assessment tests, the results of which are subject to being remotely monitored by a physician.

14. The multi-user distribution system for providing a patient with selective health-related educational information and medical products of claim 13, wherein said system automatically generates said module by electronic means upon diagnosis of said patient by a physician subscriber to said system.

15. The multi-user distribution system for providing a patient with selective diagnosis-related educational information and medical products of claim 13, wherein said system is a subscription system, providing access thereto only through the direction of a physician subscriber to said system.

16. A multi-user distribution system for providing a user with selective diagnosis-related educational information and medical products, comprising:
(1) means for inputting a user's request for a medical module correlated to said user's at least one diagnosis;
(2) means for processing said user's information request and for correlating at least one diagnosis with at least one set of expert selected materials;
(3) means for combining at least one set of materials into a medical module to be sent to the user; and
(4) means for delivering said medical module to said user;
(5) wherein said module comprises materials selected from the group comprising consumer medical tests, medical devices, printed media, taped media, electronic media, filmed media, video, and CD-ROM;
(6) wherein said means for delivering said medical module to a patient is carrier mail;
(7) wherein said system is capable of automatically generating said module by electronic means upon diagnosis of said patient by a physician subscriber to said system;
(8) wherein said system is at least one of a subscription system, providing access thereto only through the direction of a physician subscriber to said system.

17. A distribution method for providing a patient with a medical diagnosis with selective educational materials and medical products from healthcare experts comprising the steps of:
(1) selecting a set of health-related materials;
(2) presenting the patient to a subscriber of the medical subscriber system, wherein said presenting is one of direct and remote;
(3) distributing an education prescription to a patient;
(4) requesting a medical module corresponding to a specific diagnosis of a patient's medical condition from said subscriber system; and
(5) receiving a medical module from said subscriber system.

18. The method of claim 17, further comprising the step of extracting educational data from at least one database.

19. The method of claim 17, wherein said modules provide at least one of:
(a) a prescription via Internet;
(b) a prescription via mail;
(c) a prescription via e-mail;
(d) a prescription via online;
(e) a prescription via fax;
(f) a prescription via carrier; and
(g) a prescription via telephone.

20. The distribution method for providing at least one patient with a medical diagnosis according to claim 17, wherein said selecting step (1) further comprises the step of selecting educational material from at least one of printed, taped, or electronic media; and, wherein said requesting step (4) includes diagnosing medical conditions.
